(19) United States
(12) Patent Application Publication
(10) Pub. No.: US 2026/0235184 A1
(43) Pub. Date: Aug. 13, 2026

(54) Gas Spring End Member Assemblies as well as Gas Spring Assemblies and Methods of Manufacture Including Same

(71) Applicant: Firestone Industrial Products Company, LLC, Nashville, TN (US)

(72) Inventors: Suhale Manzoor, Lebanon, TN (US); Gabriel V. Onita, Arnhem (NL)

(21) Appl. No.: 19/153,595

(22) PCT Filed: Feb. 7, 2024
(86) PCT No.: PCT/US2024/014706

§ 371 Date: Aug. 4, 2025

Related U.S. Application Data
(60) Provisional application No. 63/483,933, filed on Feb. 8, 2023.

(51) Int. Cl. F16F 9/04; B60G 11/27; F16F 9/05; F16F 9/32

(52) U.S. Cl. CPC F16F 9/0463; F16F 9/057; F16F 9/3271; B60G 11/27; B60G 2202/152; B60G 2206/424; B60G 2500/201; B60G 2800/162; F16F 2222/126; F16F 2226/04; F16F 2230/0005

(57) ABSTRACT

Gas spring end member assemblies include an end member body and an endless annular ring. The end member body includes a body wall formed from polymeric material with a crimp wall portion extending axially and dimensioned to receive an end of a gas spring flexible member. The endless annular ring is positioned in abutting engagement along an inner side surface portion of the crimp wall portion. The endless annular ring provides increased radial rigidity to the crimp wall portion under radially-inward forces securing the end of the gas spring flexible member along the crimp wall portion. The crimp wall portion is disposed radially outward of the endless annular ring, which frictionally engages the inner side surface portion of the crimp wall portion but is otherwise unconstrained in at least one axial direction by the body wall. Gas spring assemblies, suspension systems, and methods of manufacture are also included.

### BACKGROUND

The subject matter of the present disclosure broadly relates to the art of gas spring devices and, more particularly, to end members assemblies that are constructed to provide increased radial stiffness and/or rigidity for crimped connections while retaining reduced residual stresses associated with the manufacture and use thereof. Gas spring assemblies including such end member assemblies as well as methods of assembly are also included.

The subject matter of the present disclosure may find particular application and use in conjunction with components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles, support structures, height adjusting systems and actuators associated with industrial machinery, components thereof and/or other such equipment. Accordingly, the subject matter of the present disclosure is not intended to be limited to use associated with suspension systems of wheeled vehicles.

Wheeled motor vehicles of most types and kinds include a sprung mass, such as a body or chassis, for example, and an unsprung mass, such as two or more axles or other wheel-engaging members, for example, with a suspension system disposed therebetween. Typically, a suspension system will include a plurality of spring elements as well as a plurality of damping devices that together permit the sprung and unsprung masses of the vehicle to move in a somewhat controlled manner relative to one another. Movement of the sprung and unsprung masses toward one another is normally referred to in the art as jounce motion while movement of the sprung and unsprung masses away from one another is commonly referred to in the art as rebound motion.

Generally, each of the plurality of damping devices is operative to dissipate energy associated with undesired inputs and movements of the sprung mass, such as road inputs occurring under dynamic operation of a vehicle, for example. Typically, such dampers are liquid filled and operatively connected between a sprung mass and an unsprung mass, such as between a body and an axle of a vehicle, for example. One example of such damping components are conventional shock absorbers that are commonly used in vehicle suspension systems.

The plurality of spring devices function to accommodate forces and loads associated with the operation and use of the vehicle. In some cases, the spring devices can take the form of gas spring assemblies that utilize pressurized gas as the working medium. Gas spring assemblies of various types, kinds and constructions are well known and commonly used. Typical gas spring assemblies can include a flexible wall that is secured between comparatively rigid end members. A wide variety of arrangements for securing the flexible wall on or along an end member have been developed, and it is recognized that different securing arrangements have different advantages, such as low cost, improved sealing or reliability, high strength and/or a capability of disassembly and/or repair, for example.

Different securing arrangements may be employed in different applications depending upon the particular conditions under which the gas spring assembly is intended for use. Additionally, or in the alternative, differing gas spring end member constructions can be utilized depending on the particular conditions to which the connection between the flexible wall and the gas spring end member are expected to be exposed. As non-limiting examples, such conditions can include applications under which elevated internal gas pressures, over-extension conditions and/or exposure to low temperatures may be experienced. In many cases, a different securing arrangement may be selected and used on each of the two different end members of a gas spring assembly.

In some cases, gas spring end members can include one or more component parts that are at least partially formed from a polymeric material, such as to reduce weight and/or reduce cost of manufacture, for example. In some such cases, the polymeric end member component may include a wall portion on or along which an end of a flexible sleeve is secured, such as by way of a crimp ring that is compressed radially inward against the end of the flexible sleeve. In such an arrangement, the end of the flexible sleeve is compressed radially inward against the polymeric wall of the end member component such that a substantially fluid-tight seal is formed therebetween. It has been recognized, however, that in such constructions time-dependent viscoelastic effects can alter the dimensions of the polymeric wall and thereby reduce or otherwise disadvantageously alter the integrity of the substantially fluid-tight connection between the end of the flexible sleeve and the polymeric wall of the end member component.

To address such issues, some constructions of polymeric gas spring end members are known to include a metal backing or support ring that is embedded within the polymeric wall of the end member component. The metal backing ring provide radial rigidity to the polymeric wall and can greatly retard viscoelastic creep that would otherwise occur over time. In many cases, such a construction is manufactured by injection molding the polymeric end member component over the metal backing or support ring such that the polymeric wall is axially coextensive with and radially outward of the metal backing ring. In such cases, the injected polymeric material flows around and along three sides of the metal backing ring. In such an arrangement, the metal backing ring is axially and radially captured within the polymeric material. However, in accordance with the subject matter of the present disclosure, it has been recognized that as the end member component and metal backing ring cool after the injection-molding process, undesirably high localized stresses are formed within certain areas of the end member component, such as adjacent the corners and/or edges of the metal backing ring. This is generally believed to at least partially result from differential coefficients of thermal expansion between the metal backing ring and the polymeric material of the end member component. Again, in accordance with the subject matter of the present disclosure, it has been recognized that such undesirably high localized stresses can lead to performance degradation and other disadvantageous characteristics of known end member assemblies.

U.S. Pat. No. 11,707,959 discloses an end member assembly for use in gas spring assemblies. The end member assembly includes multiple components with at least one of the components formed from a polymeric material with a metal reinforcing ring embedded within the polymeric clamping wall of the end member component. In the arrangement disclosed therein, the metal reinforcing ring axially radially captured within the polymeric wall of the end member component, such as has been described above.

Notwithstanding widespread usage of known end member constructions and corresponding securing arrangements, it is believed desirable to develop end members or end member assemblies for gas spring assemblies that are capable of overcoming the foregoing and/or other disadvantages of known constructions as well as providing improved retention, securement and/or performance with respect to the connection with of the flexible wall while promoting relatively low costs of manufacture, ease of assembly and/or otherwise advancing the art of gas spring devices.

### BRIEF DESCRIPTION

One example of a method of manufacture in accordance with the subject matter of the present disclosure of a gas spring assembly that has a longitudinal axis can include forming an end member body that extends axially between a first body end and a second body end. The end member body can include a body wall formed from a polymeric material. The body wall can extend peripherally around the longitudinal axis and axially between the first and second body ends. The body wall can include a crimp wall portion extending axially and including an inner side surface portion facing radially inward and an outer side surface portion facing radially outward. The method can also include positioning a first endless annular ring formed separately from the end member body in abutting engagement with inner side surface portion of the crimp wall portion of the end member body thereby at least partially forming an end member assembly. The first endless annular ring can be disposed axially coextensive with at least some of the outer side surface portion of the crimp wall portion with the first endless annular ring frictionally engaging the inner side surface portion of the crimp wall portion with the first endless annular ring physically unobstructed and otherwise unconstrained by the body wall in at least one axial direction. The method can also include positioning an end of a flexible wall of a gas spring flexible member that at least partially defines a spring chamber along the end member assembly such that the end of the flexible wall is disposed along the outer side surface of the crimp wall portion of the end member body. The method can further include positioning a second endless annular ring along the end of the flexible wall such that the second endless annular ring is axially coextensive with the crimp wall portion and the first endless annular ring. The method can also include displacing the second endless annular ring radially inward such that the second endless annular ring generates radially-inward forces compressively engaging the flexible wall along the outer side surface portion of the crimp wall portion of the end member assembly. In such an arrangement a fluid-tight seal is formed therebetween with the first endless annular ring providing increased radial rigidity to the crimp wall portion under the radially-inward forces.

One example of an end member assembly in accordance with the subject matter of the present disclosure can be dimensioned to receive an associated end of an associated gas spring flexible member. The end member assembly can include an end member body and an endless annular ring. The end member body can have a longitudinal axis and can extend axially between a first body end and a second body end. The end member body can include a body wall formed from a polymeric material. The body wall can extend peripherally around the longitudinal axis and axially between the first and second body ends. The body wall can include a crimp wall portion extending axially and dimensioned to receive the associated end of the associated gas spring flexible member. The crimp wall portion can include an outer side surface portion facing radially outward and an inner side surface portion facing radially inward. The endless annular ring is formed separately from the end member body. The endless annular ring can be positioned in abutting engagement with the crimp wall portion along the inner side surface portion thereof. The endless annular ring can be disposed axially coextensive with at least some of the outer side surface portion such that the endless annular ring provides increased radial rigidity to the crimp wall portion under radially-inward forces associated with securing the associated end of the associated gas spring flexible member along the crimp wall portion. The crimp wall portion can be disposed radially outward of the endless annular ring with the endless annular ring frictionally engaging the inner side surface portion of the crimp wall portion but otherwise unconstrained in at least one axial direction by the body wall.

One example of a gas spring assembly in accordance with the subject matter of the present disclosure can include a gas spring flexible member having a longitudinal axis. The gas spring flexible member can include a flexible wall extending peripherally about the longitudinal axis and axially between a first end and a second end to at least partially define a spring chamber therebetween. An end member assembly according to the foregoing paragraph can be at least partially received within the first end of the gas spring flexible member such that a portion of the flexible wall is disposed along the outer side surface portion of the crimp wall portion. An annular retaining ring can extend peripherally around the longitudinal axis. The annular retaining ring can be positioned coextensive with the crimp wall portion and the endless annular ring. The annular retaining ring can be disposed radially outward of the flexible spring member and can generate radially-inward forces to compressively engage the flexible wall along the outer side surface portion of the crimp wall portion of the end member assembly such that a fluid-tight seal is formed therebetween.

Another example of a gas spring assembly in accordance with the subject matter of the present disclosure can include a flexible spring member having a longitudinal axis. The flexible spring member can include a flexible wall extending peripherally about the longitudinal axis between first and second ends of the flexible spring member such that a spring chamber is at least partially defined therebetween. An end member can be secured across the first end of the flexible wall such that a fluid-tight connection is formed therebetween. And, an end member assembly can extend across the second end of the flexible wall. The end member assembly can include an end member body that can extend peripherally about the longitudinal axis. The end member body can include a body wall formed from a polymeric material. The body wall can include a crimp wall portion that includes an inner side surface portion facing radially inward and an outer side surface portion facing radially outward. The inner side surface portion can extend axially between a first inner edge and a second inner edge axially offset from the first inner edge. The crimp wall portion can be received within the second end of the flexible spring member such that the flexible wall is disposed along the outer side surface portion. A first endless annular ring is formed separately from the end member body. The first endless annular ring can include an outer peripheral side surface portion, an inner peripheral side surface portion and a first end surface portion that is oriented transverse to the longitudinal axis. The first endless annular ring can be positioned along the crimp wall portion such that the outer peripheral side surface portion is disposed in abutting engagement with the inner side surface portion of the crimp wall portion. The first endless annular ring frictionally engages the inner side surface portion of the crimp wall portion. Substantially all of the crimp wall portion from the second inner edge to the first inner edge is disposed radially outward of the first endless annular ring such that the first endless annular ring is substantially unconstrained by the crimp wall portion in at least one axial direction. A second endless annular ring can extend peripherally around the longitudinal axis. The second endless annular ring can be positioned coextensive with the crimp wall portion of the end member body and coextensive with the first endless annular ring. The second endless annular ring can be disposed radially outward of the flexible spring member such that a portion of the flexible wall is disposed between the second endless annular ring and the crimp wall portion. The second endless annular ring can generate radially-inward forces compressively engaging the flexible wall along the outer side surface portion of the crimp wall portion such that a fluid-tight seal is formed therebetween.

One example of a suspension system in accordance with the subject matter of the present disclosure can include a pressurized gas system that includes a pressurized gas source and a control device. The suspension system can also include at least one gas spring assembly according to either one of the two foregoing paragraphs. The at least one gas spring assembly can be disposed in fluid communication with the pressurized gas source through the control device such that pressurized gas can be selectively transferred into and out of the spring chamber.

### BRIEF DESCRIPTION OF THE DRAWINGS

FIG. 1 is a schematic representation of one example of a suspension system of an associated vehicle that includes one or more gas spring assemblies (or gas spring and damper assemblies) in accordance with the subject matter of the present disclosure.

FIG. 2 is a top perspective view of one example of a gas spring and damper assembly including a gas spring assembly in accordance with the subject matter of the present disclosure.

FIG. 3 is a side elevation view of the gas spring and damper assembly in FIG. 2.

FIG. 4 is an enlarged, front elevation view of the gas spring and damper assembly in FIGS. 2 and 3.

FIG. 5 is a top plan view of the gas spring and damper assembly in FIGS. 2-4.

FIG. 6 is a cross-sectional side view of the gas spring and damper assembly in FIGS. 2-5 taken from along line 6 -6 in FIG. 5.

FIG. 7 is an enlarged view of the portion of the gas spring and damper assembly in FIGS. 2-6 identified as Detail 7 in FIG. 6.

FIG. 8 is a cross-sectional plan view of the gas spring and damper assembly in FIGS. 2-7 taken from along line 8 -8 in FIG. 7.

FIG. 9 an enlarged view of the portion of the end member assembly in FIGS. 2-8 identified as Detail 9 in FIG. 7.

FIG. 10 illustrates an alternate arrangement of an end member assembly in accordance with the subject matter of the present disclosure.

FIG. 11 illustrates another alternate arrangement of an end member assembly in accordance with the subject matter of the present disclosure.

FIG. 12 is an enlarged, exploded view of an end member assembly in accordance with the subject matter of the present disclosure, such as is shown in FIGS. 2-11, for example.

FIG. 13 is a plot illustrating predicted stresses of an end member assembly in accordance with the subject matter of the present disclosure undergoing an otherwise conventional radially-inward crimping action.

FIG. 14 is a plot illustrating predicted stresses of an end member assembly in accordance with the subject matter of the present disclosure that are residual after cessation of an otherwise conventional radially-inward crimping action.

FIG. 15 illustrates an enlarged view of a conventional end member assembly with an over-molded backing ring.

FIG. 16 is a plot illustrating predicted stresses of a conventional end member assembly with an over-molded backing ring that are residual from differential coefficients of thermal expansion between the over-molded backing ring and the end member body.

FIG. 17 is a plot illustrating predicted stresses of a conventional end member assembly undergoing a conventional radially-inward crimping action.

FIG. 18 is a plot illustrating predicted stresses of a conventional end member assembly that are residual after cessation of a conventional radially-inward crimping action.

### DETAILED DESCRIPTION

Turning now to the drawings, it is to be understood that the showings are for purposes of illustrating examples of the subject matter of the present disclosure and that such examples are merely illustrative and are not intended to be interpreted as limiting. Additionally, it will be appreciated that the drawings are not to scale and that portions of certain features and/or elements may be exaggerated for purposes of clarity and/or ease of understanding.

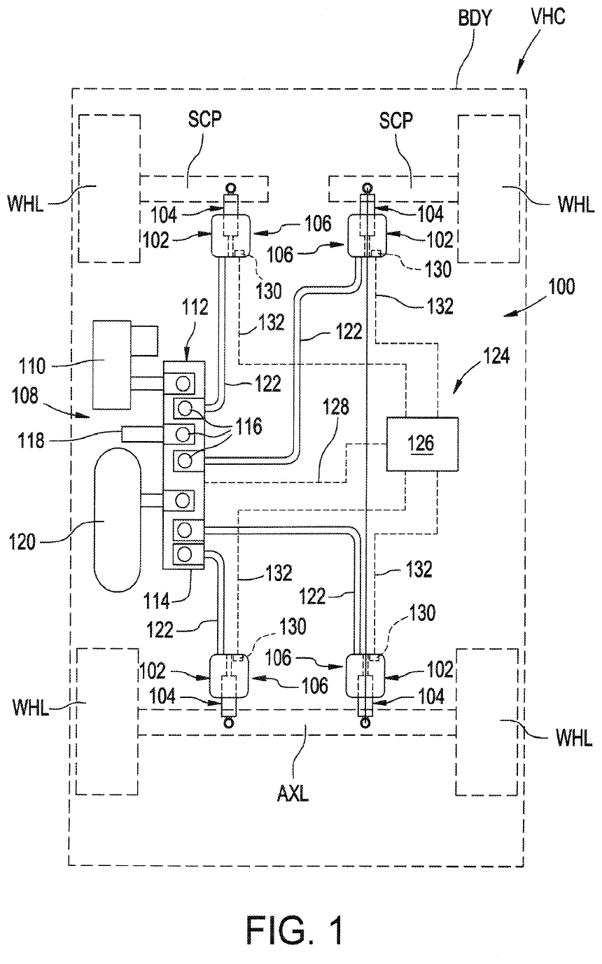

FIG. 1 illustrates one example of a suspension system 100 operatively disposed between a sprung mass, such as an associated vehicle body BDY, for example, and an unsprung mass, such as associated wheels WHL, associated axles AXL and/or associated suspension components SCP, for example, of an associated vehicle VHC. It will be appreciated that any one or more of the components of the suspension system can be operatively connected between the sprung and unsprung masses of the associated vehicle in any suitable manner. The suspension system includes one or more gas spring assemblies in accordance with the subject matter of the present disclosure as well as one or more damper assemblies that are operatively connected between the sprung and unsprung masses and together permit the sprung and unsprung masses of the associated vehicle to move in a somewhat controlled manner relative to one another, as discussed above.

Depending on desired performance characteristics and/or other factors, the one or more gas spring assemblies can, in some cases, be provided and installed separately from the one or more damper assemblies. Additionally, or in the alternative, a gas spring assembly can be assembled together with a damper assembly such that at least a portion of the gas spring assembly is axially coextensive with the damper assembly to form so-called gas spring and damper assemblies. It will be appreciated that gas spring assemblies and components thereof in accordance with the subject matter of the present disclosure are shown and described herein with particular reference to gas spring and damper assemblies. It is to be recognized and understood, however, that such a construction is optional and that gas spring assemblies in accordance with the subject matter of the present disclosure (as well as the components and assemblies thereof) are not intended to be limited to use in gas spring and damper assemblies.

As shown in FIG. 1, suspension system 100 can include a plurality of gas spring assemblies 102 that are operatively connected between the sprung and unsprung masses of the vehicle. Additionally, suspension system 100 can include a plurality of damper assemblies 104 that are operatively connected between the sprung and unsprung masses of the vehicle. Depending on desired performance characteristics and/or other factors, the suspension system can include any suitable number of one or more gas spring assemblies and one or more damper assemblies. Furthermore, the one or more gas spring assemblies and the one or more damper assemblies can be operatively connected on, along or otherwise between the sprung and unsprung masses in any suitable manner. As one non-limiting example, gas spring assembly 102 and damper assembly 104 can, optionally, be operatively connected in an axially-coextensive arrangement to form one or more gas spring and damper assemblies 106 that can then be operatively connected on, along or otherwise between the sprung and unsprung masses as a unit.

Suspension system 100 also includes a pressurized gas system 108 operatively associated with at least gas spring assemblies 102 for selectively supplying pressurized gas (e.g., air) thereto and selectively transferring pressurized gas therefrom. In the exemplary arrangement shown in FIG. 1, pressurized gas system 108 includes a pressurized gas source, such as a compressor 110, for example, for generating pressurized air or other gases. A control device, such as a valve assembly 112, for example, is shown as being in communication with compressor 110 and can be of any suitable configuration or arrangement. In the exemplary embodiment shown, valve assembly 112 includes a valve block 114 with a plurality of valves 116 supported thereon. Valve assembly 112 can also, optionally, include a suitable exhaust, such as a muffler 118, for example, for venting pressurized gas from the system. Optionally, pressurized gas system 108 can also include a reservoir 120 in fluid communication with the compressor and/or valve assembly 112 and suitable for storing pressurized gas for an extended period of time (e.g., seconds, minutes, hours, weeks, days, months).

Valve assembly 112 is in communication with gas spring assemblies 102 through suitable gas transfer lines 122. As such, pressurized gas can be selectively transferred into and/or out of the gas spring assemblies through valve assembly 112 by selectively operating valves 116, such as to alter or maintain vehicle height at one or more corners of the vehicle, for example.

Suspension system 100 can also include a control system 124 that is capable of communication with any one or more systems and/or components of vehicle VHC and/or suspension system 100, such as for selective operation and/or control thereof. Control system 124 can include a controller or electronic control unit (ECU) 126 communicatively coupled with compressor 110 and/or valve assembly 112, such as through a conductor or lead 128, for example, for selective operation and control thereof, which can include supplying and exhausting pressurized gas to and/or from gas spring assemblies 102. Controller 126 can be of any suitable type, kind and/or configuration.

Control system 124 can also, optionally, include one or more sensing devices 130, such as, for example, may be operatively associated with gas spring assemblies 102 (or gas spring and damper assemblies 106) and capable of outputting or otherwise generating data, signals and/or other communications having a relation to one or more of: a height of the gas spring assemblies (or gas spring and damper assemblies); a distance between other components of the vehicle; a pressure or temperature having a relation to the gas spring assemblies (or gas spring and damper assemblies) and/or a wheel or tire or other component associated with the gas spring assemblies (or gas spring and damper assemblies); and/or an acceleration, load or other input acting on the gas spring assemblies (or gas spring and damper assemblies). Sensing devices 130 can be in communication with ECU 126, which can receive the data, signals and/or other communications therefrom. The sensing devices can be in communication with ECU 126 in any suitable manner, such as through conductors or leads 132, for example. Additionally, it will be appreciated that the sensing devices can be of any suitable type, kind and/or construction and can operate using any suitable combination of one or more operating principles and/or techniques.

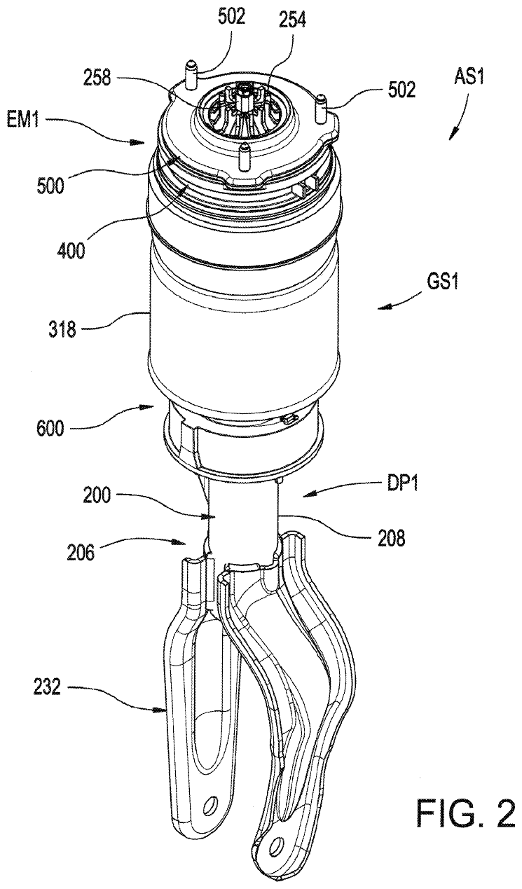

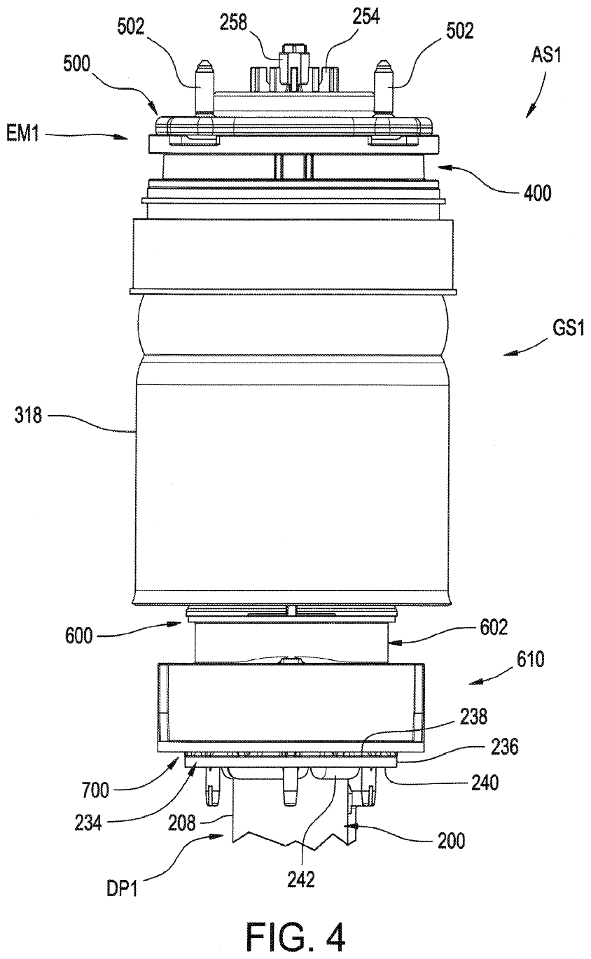

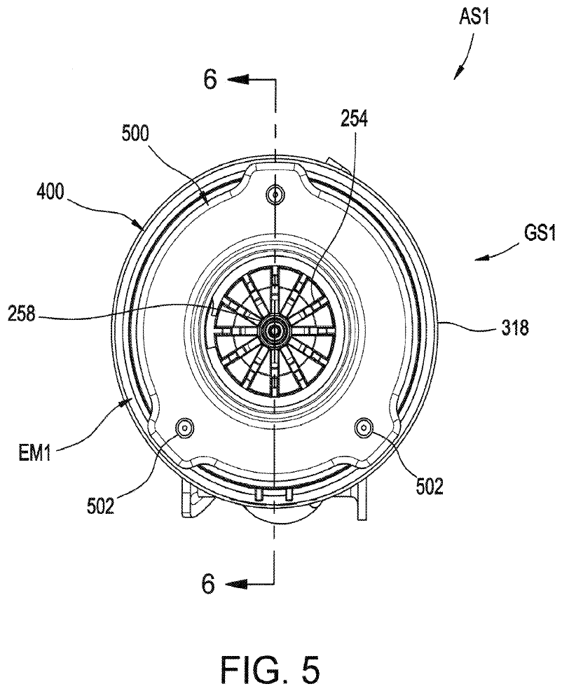

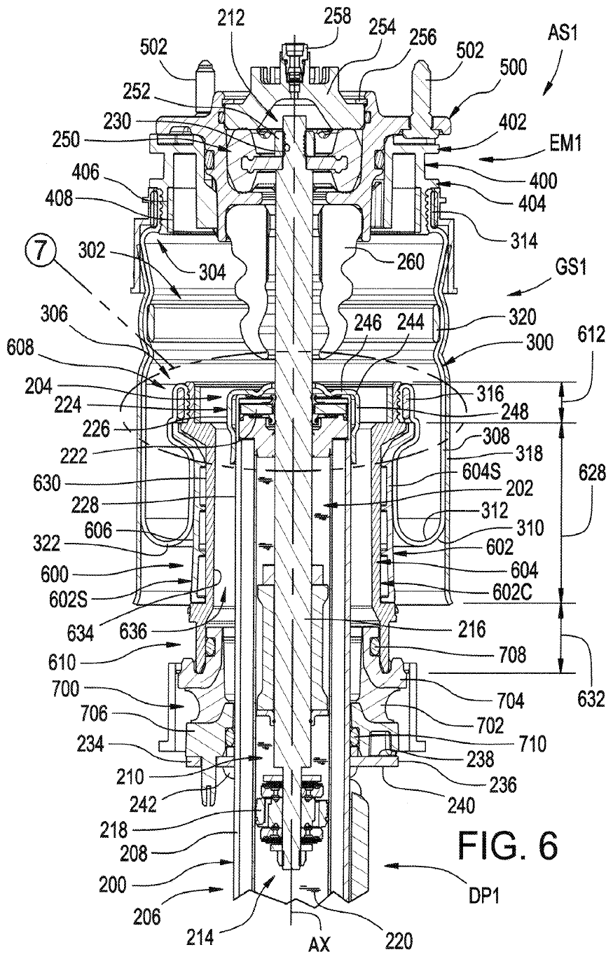

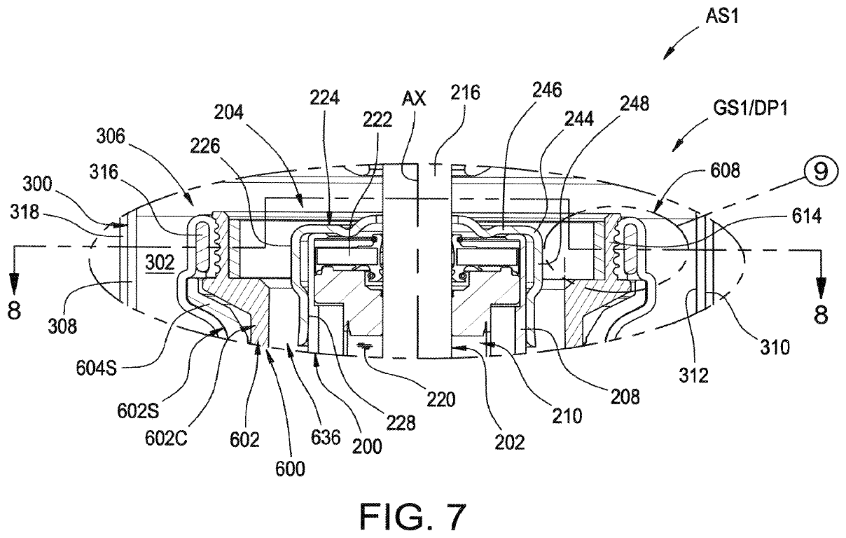

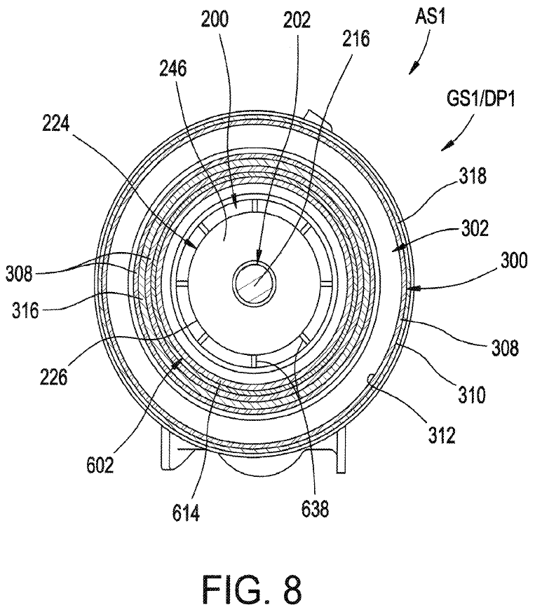

Having described an example of a suspension system (e.g., suspension system 100) that can include gas spring assemblies in accordance with the subject matter of the present disclosure, an example of such a gas spring assembly will now be described in connection with FIGS. 2-14. As shown therein, a gas spring and damper assembly AS1, such as may be suitable for use as one or more of gas spring and damper assemblies 106 in FIG. 1, is shown as including a gas spring (or gas spring assembly) GS1 in accordance with the subject matter of the present disclosure, such as may correspond to one of gas spring assemblies 102 in FIG. 1, for example. Additionally, gas spring and damper assembly AS1 can, optionally, include a damper (or damper assembly) DP1 such as may correspond to one of dampers 104 in FIG. 1, for example. Gas spring assembly GS1 and damper assembly DP1 can, optionally, be disposed in a coextensive arrangement with one another, and can be operatively secured to one another in any suitable manner, such as is described hereinafter, for example. A longitudinal axis AX extends lengthwise along assembly AS1, as shown in FIGS. 6 and 7.

Damper assembly DP1 can include a damper housing 200 and a damper rod assembly 202 that is at least partially received in the damper housing. Damper housing 200 extends axially between housing ends 204 and 206, and includes a housing wall 208 that at least partially defines a damping chamber 210. Damper rod assembly 202 extends lengthwise between opposing ends 212 and 214 and includes an elongated damper rod 216 and a damper piston 218 disposed along end 214 of damper rod assembly 202. Damper piston 218 is received within damping chamber 210 of damper housing 200 for reciprocal movement along the housing wall in a conventional manner. A quantity of damping fluid 220 can be disposed within damping chamber 210, and damper piston 218 can be displaced through the damping fluid to dissipate kinetic energy acting on gas spring and damper assembly AS1. Though damper assembly DP1 is shown and described herein as having a conventional construction in which a hydraulic fluid is contained within at least a portion of damping chamber 210, it will be recognized and appreciated that dampers of other types, kinds and/or constructions, such as pressurized gas or “air” dampers, for example, could be used without departing from the subject matter of the present disclosure.

That is, it will be appreciated that a gas spring and damper assembly in accordance with the subject matter of the present disclosure can, in some cases, include a damper of an otherwise conventional construction that utilizes hydraulic oil or other liquid as a working medium of the damper. In other cases, the damper can be of a type and kind that utilizes pressurized gas as a working medium. In such cases, such a gas damper can include one or more elongated gas damping passages through which pressurized gas can flow to generate pressurized gas damping to dissipate kinetic energy acting on the gas spring and damper assembly. It will be appreciated that such one or more elongated gas damping passages can be of any suitable size, shape, configuration and/or arrangement. Additionally, it will be appreciated that any number of one or more features and/or components can be used, either alone or in combination with one another, to form or otherwise establish such one or more elongated gas damping passages.

Housing wall 208 can form an opening (not numbered) along housing end 204. A damper end wall 222 can extend across the opening and can be secured on or along housing wall 218 such that a substantially fluid-tight connection is formed therebetween. Damper end wall 222 can include an opening (not numbered) and elongated damper rod 216 can extend axially outward from damping chamber 210 through the opening in a direction opposite housing end 206. Additionally, a damper end wall (not numbered) can be connected across end 206 of damper housing 200 such that a substantially fluid-tight connection is formed therebetween. In some cases, an end cap 224 (which is sometimes referred to in the art as a striker cap) that includes an outer side surface portion 226 can be supported on or along end 204 of damper housing 200. In other cases, an outside surface portion 228 of housing wall 208 can be exposed on or along end 204 of the damper housing.

Elongated damper rod 216 can project outwardly from damper end wall 222 such that end 212 of the damper rod assembly is outwardly exposed from the damper housing and is externally accessible with respect to the damper housing. A connection structure 230, such as a plurality of threads, for example, can be provided on or along the elongated rod for use in operatively connecting damper assembly DP1, either directly or indirectly, to an associated vehicle structure, a component of gas spring assembly GS1 or another component of gas spring and damper assembly AS1.

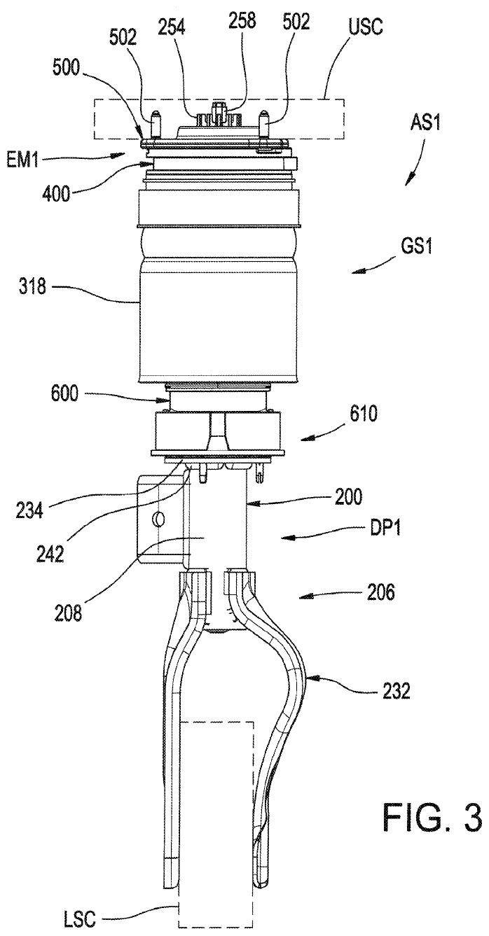

It will be appreciated that gas spring and damper assembly AS1 can be operatively connected between associated sprung and unsprung masses of an associated vehicle (or other construction) in any suitable manner. For example, one end of the assembly can be operatively connected to an associated sprung mass with the other end of the assembly disposed toward and operatively connected to an associated unsprung mass. As shown in FIG. 3, for example, end 212 of damper rod assembly 202 can be operatively engaged (either directly or indirectly) with a first or upper structural component USC, such as associated vehicle body BDY in FIG. 1, for example, and can be secured thereon in any suitable manner. As one non-limiting example, gas spring assembly GS1 can include an end member (also referred to herein as an end member assembly) EM1 that can be secured to upper structural component USC. One or more components of gas spring assembly GS1 and/or one or more components of damper assembly DS1 can be operatively connected to end member assembly EM1. Additionally, or in the alternative, damper assembly DP1 can include a mounting bracket 232 disposed along end 206 of damper housing 200, which can be secured on or along a second or lower structural component LSC (FIG. 3), such as associated axle AXL and/or associated suspension component SCP in FIG. 1, for example, and can be secured thereon in any suitable manner.

Gas spring assembly GS1 can include a flexible spring member 300 that extends peripherally around axis AX and can be secured between opposing end members (or end member assemblies) in a substantially fluid-tight manner such that a spring chamber 302 is at least partially defined therebetween. As a non-limiting example, end member assembly EM1 can include an end member (also referred to herein as an end member assembly) 400 to which an end 304 of flexible spring member 300 can be secured and an end member (also referred to herein as an end member assembly) 500 to which end 212 of damper rod assembly 202 can be operatively connected. Additionally, or in the alternative, gas spring assembly GS1 includes an end member (also referred to herein as an end member assembly) 600 in accordance with the subject matter of the present disclosure that is supported on or along damper housing 200. An end 306 of flexible spring member 300 that is opposite end member 400 can be secured on or along end member assembly 600 in any suitable manner, such as described in greater detail hereinafter, for example.

It is to be distinctly understood that end members (which can alternately be referred to herein as end member assemblies) constructed in accordance with the subject matter of the present disclosure can include one or more end member bodies. As such, the subject matter of the present disclosure is not intended to be limited to use in connection with end members that are assembled from two or more end member bodies. As such, it is to be distinctly understood that the configurations of end members shown and described herein that include two or more end member bodies are merely exemplary and are not intended to be limiting. What's more, it is to be distinctly understood that end members in accordance with the subject matter of the present disclosure can-in some cases-be constructed for securement on or along one end of a flexible sleeve, such as may function as “upper” end caps and/or “upper” housings, and that such end caps and/or housings can be formed from one or more end member bodies. Additionally, or in the alternative, end members in accordance with the subject matter of the present disclosure can-in some cases-be constructed for securement on or along the other end of a flexible sleeve, such as may function as “lower” end caps and/or “lower” pistons, and that such end caps and/or pistons can be formed from one or more end member bodies. Again, as indicated above, it is to be distinctly understood that the configurations of end members shown and described herein that include two or more end member bodies are merely exemplary and are not intended to be limiting.

For example, it is to be distinctly understood that end member assembly EM1 can, optionally, include or otherwise be constructed with components and structures in accordance with the subject matter of the present disclosure, such as those that are described in greater detail hereinafter. As another non-limiting example, it will be appreciated that end member 400 and/or end member 500 can, optionally, include or otherwise be constructed with components and structures in accordance with the subject matter of the present disclosure, such those that are described in greater detail hereinafter. As a further non-limiting example, it will be appreciated that end member assembly 600 can, optionally, include or otherwise be constructed with components and structures in accordance with the subject matter of the present disclosure, such as is described in greater detail hereinafter.

Additionally, it will be appreciated that end member assembly 600 can be operatively supported on or along damper housing 200 in any suitable manner. As a non-limiting example, damper assembly DP1 can include a support wall or support wall portion 234 that extends radially outward from along the damper housing toward an outer peripheral edge 236. Support wall portion 234 can include a surface portion 238 facing toward end 204 of damper housing 200 and a surface portion 240 facing toward end 206 of the damper housing. Support wall portion 234 can be supported on or along the damper housing in any suitable manner, such as by way of one or more flowed-material joints 242, for example. If included, end cap 224 can include a cap wall 244 with an end wall portion 246 oriented transverse to longitudinal axis AX and a side wall portion 248 extending axially about the longitudinal axis. Side wall portion 248 can include outer side surface portion 226 that faces radially outward and forms an outermost peripheral extent of damper assembly DP1 along end 204 of the damper housing.

It will be appreciated that flexible spring member 300 can be of any suitable size, shape, construction and/or configuration. Additionally, the flexible spring member can be of any type and/or kind, such as a rolling lobe-type or convoluted bellows-type construction, for example. Flexible spring member 300 is shown in FIGS. 2-12 and 15 as including a flexible wall 308 that can be formed in any suitable manner and from any suitable material or combination of materials. For example, the flexible wall can include one or more fabric-reinforced, elastomeric plies or layers and/or one or more un-reinforced, elastomeric plies or layers. Typically, one or more fabric-reinforced, elastomeric plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

Flexible wall 308 can extend in a generally longitudinal direction between opposing ends 304 and 306. Additionally, flexible wall 308 can include an outer surface 310 and an inner surface 312. The inner surface can at least partially define spring chamber 302 of gas spring assembly GS1. In some cases, flexible wall 308 can include an outer or cover ply (not identified) that at least partially forms outer surface 310. Additionally, or in the alternative, flexible wall 308 can also include an inner or liner ply (not identified) that at least partially forms inner surface 312. In some cases, flexible wall 308 can further include one or more reinforcing plies (not shown) disposed between outer and inner surfaces 310 and 312. The one or more reinforcing plies can be of any suitable construction and/or configuration. For example, the one or more reinforcing plies can include one or more lengths of filament material that are at least partially embedded therein. Additionally, it will be appreciated that the one or more lengths of filament material, if provided, can be oriented in any suitable manner. As one example, the flexible wall can include at least one layer or ply with lengths of filament material oriented at one bias angle and at least one layer or ply with lengths of filament material oriented at an equal but opposite bias angle.

Flexible spring member 300 can include any feature or combination of features suitable for forming a substantially fluid-tight connection with end member 400 of end member assembly EM1 and/or suitable for forming a substantially fluid-tight connection with end member assembly 600. For example, in some cases, end member 400 can-in accordance with the subject matter of the present disclosure-include an end member body 402 that includes an end member wall 404 with a crimp wall portion 406 and an endless annular ring 408 positioned axially coextensive with the crimp wall portion. As discussed in greater detail hereinafter in connection with end member 600, endless annular ring 408 is disposed in abutting engagement along an inner surface portion of the crimp wall portion to buttress the same under radially-inward forces associated with attaching and retaining an end of the flexible wall of the flexible spring member on or along crimp wall portion 406. As one example, flexible spring member 300 can include ends that are secured on or along the corresponding end members by way of one or more retaining (or crimp) rings 314 and 316. Alternately, a mounting bead (not shown) can be disposed along one of the ends of the flexible wall. In some cases, the mounting bead, if provided, can, optionally, include a reinforcing element, such as an endless, annular bead wire, for example. In some cases, a restraining cylinder 318 and/or other components can be disposed radially outward along flexible wall 308. In some cases, such components can be secured on or along the flexible wall in a suitable manner, such as by way or one or more backing rings 320 disposed in abutting engagement on or along the flexible wall, for example.

As mentioned above, gas spring and damper assembly AS1 can be disposed between associated sprung and unsprung masses of an associated vehicle in any suitable manner. For example, one component can be operatively connected to the associated sprung mass with another component disposed toward and operatively connected to the associated unsprung mass. As shown in FIGS. 2-6, for example, end member 500 can include one or more fasteners 502 operable to secure end member assembly EM1 on or along upper structural component USC, such as associated vehicle body BDY in FIG. 1, for example. Damper assembly DP1 can be operatively connected to the upper structural component by way of end member assembly EM1, and can be operatively engaged with the end member assembly in any suitable manner. For example, damper assembly DP1 can include a bushing 250 supported on or along end member 500 and to which damper rod assembly 202 is secured, such as by way of a connector 252 engaging connection structure 230 along end 212 of elongated damper rod 216, for example. Bushing 250 can be supported on or along end member 500 and can be operatively secured thereto in any suitable manner. As a non-limiting example, bushing 250 could be captured between end member 500 and an end cap 254 that can be secured on or along the end member in a suitable manner, such as by way of a retaining ring 256, for example. In some cases, a connector fitting 258 can extend through or otherwise be disposed on or along end cap 254, such as may provide communicative coupling of electrical and/or pressurized gas systems and/or devices with gas spring and damper assembly AS1.

It will be appreciated that gas spring and damper assembly AS1 is displaceable, during use in normal operation, between extended and compressed conditions. In some cases, one or more jounce bumpers can be included to inhibit contact between one or more features and/or components of assembly AS1. For example, damper assembly DP1 can include a jounce bumper 260 positioned on or along elongated damper rod 216 within spring chamber 302. It will be appreciated that the jounce bumper, if provided, can be supported in any suitable manner. As a non-limiting example, jounce bumper 260 can be supported on end member assembly 500 to substantially inhibit contact between a component of damper assembly DP1 and end member assembly 500 during a full jounce condition of assembly AS1. It will be appreciated, however, that other configurations and/or arrangements could alternately be used.

Additionally, as discussed above, gas spring and damper assembly AS1 can experience or otherwise undergo relative rotation during displacement between extended and compressed conditions. It will be appreciated that such relative rotation can be disadvantageous to flexible spring member 300, and that gas spring and damper assemblies commonly include on or more features, components and/or constructions operable to isolate such relative rotation from the flexible spring member. For example, in some cases, the operative connection to upper structural component USC can include one or more rotatable or twistable components. In such cases, end member assembly 600 can be directly supported in a substantially-fixed rotational position on or along the support wall of the damper assembly. In other cases, however, end member assembly EM1 can be secured on or along upper structural component USC in a substantially-fixed rotational orientation. In such cases, gas spring and damper assembly AS1 can include a torsional isolator 700 that can be supported on or along support wall portion 234 of damper assembly DP1. Torsional isolator 700 can include an elastomeric or otherwise compliant body 702 supported between a (comparatively) rigid body 704 and a (comparatively) rigid body 706. It will be appreciated that compliant body 702 can be permanently secured (i.e., inseparable without damage, destruction or material alteration of at least one of the component parts) to and/or between rigid bodies 704 and 706, such as by way of a cured joint (e.g., vulcanized) and/or a flowed-material joint.

Rigid body 704 can be operatively connected with end member assembly 600 such that a substantially-fixed rotational position is maintained therebetween. In some cases, a seal 708 can be sealingly disposed between rigid body 706 and damper housing 200 such that a fluid-tight arrangement is formed therebetween. Additionally, or in the alternative, a seal 710 can be sealingly disposed between rigid body 704 and end member assembly 600 such that a fluid-tight arrangement is formed therebetween. During use, rigid body 706 is maintained in a substantially-fixed rotational position relative to damper assembly DP1, and rigid body 704 is maintained in a substantially-fixed rotational position relative to end member assembly 600. As such, seal 708 and/or seal 710, if included, can each form a substantially-static seal arrangement between the corresponding components rather than forming a dynamic seal arrangement, such as may be used in known constructions. Accordingly, rotational displacement that may occur during use between one or more components of damper assembly DP1 and one or more components of gas spring assembly GS1 is isolated (or at least substantially reduced) from flexible spring member 300 by deflection of compliant body 702, which permits rigid bodies 704 and 706 to rotate relative to one another about longitudinal axis AX.

End member assembly 600 is of a type and kind commonly referred to as a roll-off piston or roll-off piston assembly. It will be appreciated that end member assembly 600 can include any suitable number of one or more components, structures and/or elements. For example, end member assembly 600 can include an end member body 602 that includes an end member (or body) wall 604 with any suitable number of one or more wall portions. As one non-limiting example of a suitable construction, end member body 602 can, optionally, take the form of a two-piece body construction that includes an end member core 602C that is disposed along and supported on damper housing 200, such as by way of torsional isolator 700, as described above. Such an optional construction for end member body 602 can also include an end member shell (or one or more shell sections) 602S that can be supported on or along the end member core. Regardless of the type and kind of construction used, end member body 602 can include an outer surface 606 along which a rolling lobe 322 of flexible spring member 300 can be displaced as gas spring assembly GS1 (either alone or configured as gas spring and damper assembly AS1) is displaced between compressed and extended conditions. If included, it will be appreciated that end member core 602C can be configured to receive and support one or more of end member shells and/or shell sections 602S, such as may have any one of a wide variety of different sizes, shapes and/or configurations (e.g., outer profiles with different combinations of contours and/or shapes). However, it is to be recognized and understood that such a two-piece construction is not required but merely exemplary. As such, it is to be recognized and understood that the subject matter of the present disclosure is broadly applicable to end member assemblies and end member bodies thereof having other suitable constructions and/or configurations. Accordingly, any other end member assemblies and/or end member bodies thereof could alternately be used without departing from the subject matter of the present disclosure, such as has been discussed above, for example.

Additionally, it will be appreciated that end member assembly 600 and the one or more components and/or elements thereof can be formed from any suitable material or combination of materials, and can include any suitable number or combination of one or more walls and/or wall portions. For example, end member body 602 and end member wall 604 thereof can be formed from a suitable polymeric material or combination of polymeric materials, such as a fiber-reinforced polypropylene, a fiber-reinforced polyamide, or an unreinforced (i.e., relatively high-strength) thermoplastic (e.g., polyester, polyethylene, polyamide, polyether or any combination thereof), for example.

End member body 602 is shown as extending peripherally about axis AX and longitudinally between opposing ends 608 and 610. End member body 602 can include a first or upper mounting section 612 toward end 608 and on or along which end 306 of flexible spring member 300 can be operatively connected in a suitable manner. For example, retaining ring 316 can be crimped radially-inward or otherwise deformed to form a substantially fluid-tight connection between end 306 of flexible spring member 300 and mounting section 612 of end member body 602. In this manner, spring chamber 302 can be at least partially defined by flexible spring member 300 between end member 400 and end member assembly 600, such as has been described above.

End member wall 604 can include an outer or crimp wall portion 614 disposed toward end 608 that terminates at an end surface portion 616. In a preferred arrangement, crimp wall portion 614 can take the form of an endless, annular wall that extends circumferentially about end member body 602. In some cases, crimp wall portion 614 can at least partially define an outermost periphery along a longitudinal section of end member body 602, such as along upper mounting section 612, for example. Crimp wall portion 614 can include an inner side surface portion 618 extending peripherally around longitudinal axis AX and facing radially inward. Inner side surface portion 618 also extends axially from along an annular edge or axial extent 620 toward an annular edge or axial extent 622 that is offset from annular edge 620 in an axial direction toward end 610.

Crimp wall portion can also include an outer side surface portion 624 extending peripherally around longitudinal axis AX and facing radially outward opposite inner side surface portion 618. In some cases, the crimp wall portion can, optionally, include one or more engagement features disposed along the outer side surface portion thereof that may be suitable for engaging an end or other surface portion of flexible spring member 300 to thereby enhance retention of the flexible spring member on the end member assembly in an assembled condition. As a non-limiting example, crimp wall portion 614 can include a plurality of axially-spaced, endless, annular grooves 626 disposed along outer side surface portion 624. It will be appreciated, however, that other configurations and/or arrangements could alternately be used.

End member body 602 can also include a second or intermediate section 628 that extends from along upper mounting section 612 in a direction toward end 610 of the end member body. Intermediate section 628 can include an outer side surface portion 630 dimensioned to receivingly engage one or more of end member shells or sections 602S, if included, which can be secured therealong in any suitable manner. As one example, end member shells 602S can include a shell body wall portion 604S that can be split or, alternately, formed into two or more end member shell sections 602S that can be assembled together around intermediate section 628. It will be appreciated, however, that other configurations and/or arrangements could alternately be used. Additionally, shell body wall portion 604S can include a contoured outer surface portion (not numbered) that at least partially forms outer surface 606 of end member assembly 600 along which rolling lobe 322 is displaced during use.

End member wall 604 of end member body 602 can also include a third or lower mounting section 632 disposed at or along end 610 that can be dimensioned or otherwise configured to at least partially support end member assembly 600 in an axial direction on or along damper assembly DP1. End member wall 604 can also include an inner surface portion 634 that can at least partially define a passage 636 through end member body 602. End member wall 604 can, optionally, include one or more elongated ribs 638 that can be disposed in peripherally-spaced relation to one another about axis AX and can extend longitudinally along inner surface portion 634. If included, elongated ribs 638 can be dimensioned to form a sliding or clearance fit along outer surface 228 of damper housing 200.

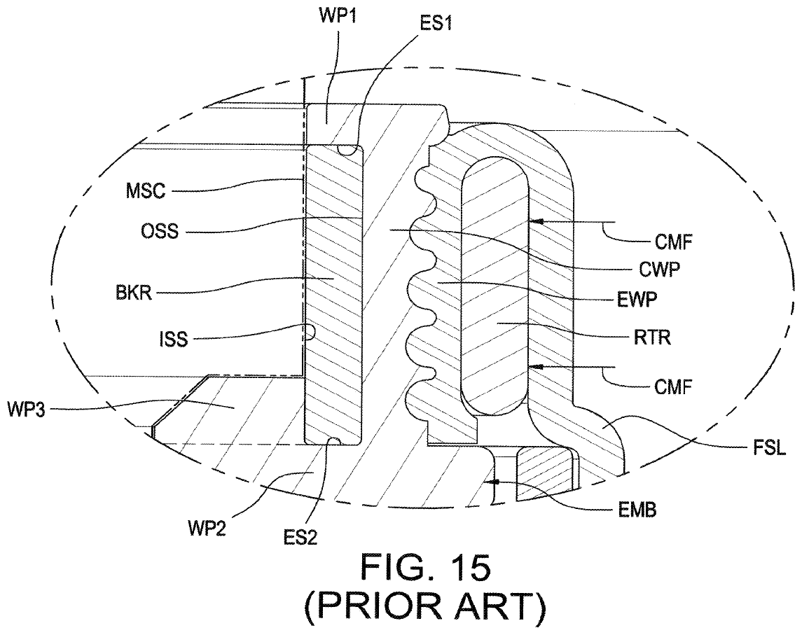

It is well understood that forming and maintaining a substantially fluid-tight seal between the end of a flexible spring member and the associated end member or end member assembly provides for the desired performance characteristics of gas spring assemblies. As such, in some known constructions, an end wall portion EWP of a flexible sleeve FSL is secured along a crimp wall portion CWP of an end member EMB using a retaining ring RTR that is displaced radially inward such that end wall portion EWP is compressed between crimp wall portion CWP and retaining ring RTR, such as is shown in FIG. 15, for example. It has been recognized that end members formed from polymeric material are known to deflect radially inward under the forces associated with deformation of retaining ring RTR radially inward to compress end wall portion EWP against crimp wall portion CWP. As such, some known constructions include a backing ring BKR that is embedded within end member EMB radially inward of and extending axially along crimp wall portion CWP. Backing ring BKR is typically formed from metal or another material that has substantially greater rigidity than the polymeric material of end member EMB. As such, in known constructions, backing ring BKR buttresses crimp wall portion CWP. As a result, the combination of crimp wall portion CWP and backing ring BKR results in increased radial rigidity of the crimp wall portion for resisting the forces associated with deformation of retaining ring RTR radially inward to compress end wall portion EWP against crimp wall portion CWP as a result of a process or effect commonly referred to as time-dependent viscoelastic creep.

It is common practice to manufacture end member EMB with backing ring BKR embedded within crimp wall portion CWP such that the backing ring is captured in both axial directions by the polymeric material of the end member. Typically, backing ring BKR will take the form of an endless annular ring that includes an outer side surface OSS, an inner side surface ISS and opposing end surfaces ES1 and ES2. In many cases, end member EMB is formed by an injection molding (or other similar) process with backing ring BKR inserted into the mold cavity before the polymeric material in flowable form (e.g., melted) is injected. Using such manufacturing techniques, a mold section MSC at least partially defines an innermost extent of the mold cavity within which backing ring BKR is disposed and within which the flowable polymeric material is injected to form end member EMB around backing ring BKR. In many cases, mold section MSC will abuttingly engage or at least form a close fit with backing ring BKR to substantially inhibit the flow of polymeric material along at least a portion of inner side surface ISS. However, the mold cavity is typically configured such that an end member wall portion WP1 is formed along end surface ES1 and an end member wall portion WP2 is formed along end surface ES2 of the backing ring. In some cases, an end member wall portion WP3 can be formed along at least a portion of inner side surface ISS.

In such known constructions, backing ring BKR is typically captured in both axial directions by the end member wall portions WP1 and WP2, which material is molded around opposing end surfaces ES1 and ES2 of the backing ring. Additionally, in some cases, such known constructions can include end member wall portion WP3 disposed along at least a portion of inner side surface ISS of backing ring BKR. It has been recognized that known constructions and methods of manufacture can undesirably generate stresses within the polymeric material of end member EMB of a sufficient magnitude so as to result in decreased performance and/or longevity of these conventional constructions.

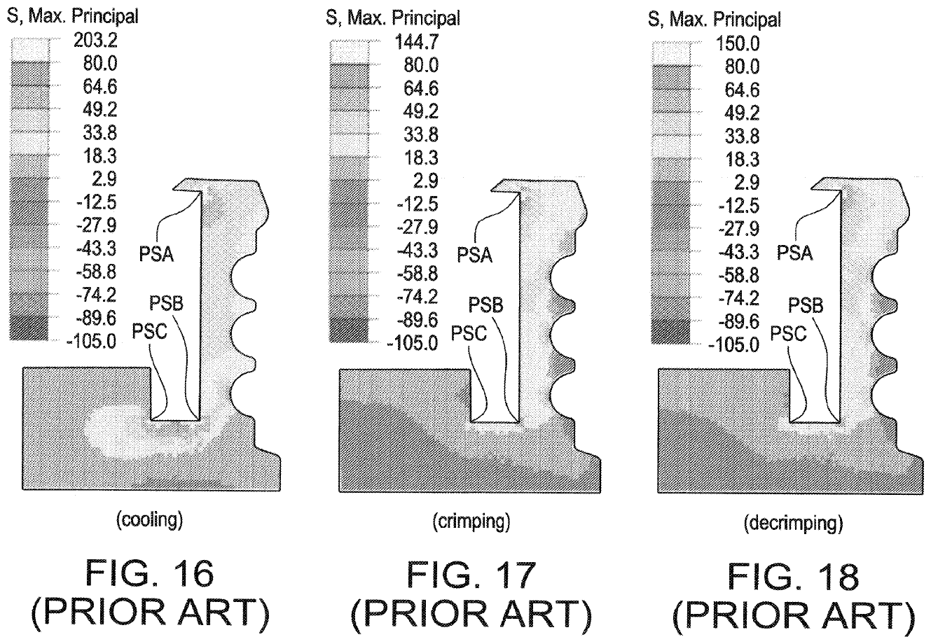

More specifically, FIGS. 16-18 illustrate graphical representations of stresses within the polymeric material of end member EMB under various conditions of manufacture and use. Because end member EMB is formed from a polymeric material and backing ring BKR is typically formed from a metal material (e.g., steel or aluminum), differences in the coefficient of thermal expansion of each material result in the end member and the embedded backing ring changing size at different rates as the assembly cools upon being removed from the injection mold. As such, residual stresses having an undesirably high value can be generated in certain areas within the polymeric material of end member EMB, particularly in certain areas where the polymeric material interfaces with backing ring BKR, such as are illustrated by areas PSA, PSB and PSC in FIG. 16 has having stresses substantially greater than in other areas of the end member. For example, the stresses in area PSA are predicted to exceed about 200 MPa with the stresses in areas PSB and PSC, respectively, predicted to be at or exceed 160 MPa and 110 MPa, as estimated using finite element modeling and analysis.

Additionally, it has been recognized that actions of crimping or otherwise generating radially-inward forces, as represented by arrows CMF, to deform retaining ring RTR radially inward and thereby compressively engage end wall portion EWP of flexible sleeve FSL along crimp wall portion CWP can somewhat alleviate the undesirably high stresses associated with the cooling process in one or more the previously identified areas of the polymeric material that interface with backing ring BKR. However, it has been recognized that such residual stresses remain at undesirably high levels. For example, the stresses in areas PSA, PSB and PSC are shown in FIG. 17 as being predicted to potentially exceed about 145 MPa in area PSA, 60 MPa in area PSB and 40 MPa in area PSC, as estimated using finite element modeling and analysis. Furthermore, it has been recognized that residual stresses having an undesirably high value can remain in one or more of the aforementioned areas of the polymeric material that interface with backing ring BKR even upon abatement of crimping forces CMF associated with deforming retaining ring RTR. That is, once retaining ring RTR has been deformed into a final crimped condition and end wall portion EWP is compressively disposed between crimp wall portion CWP and the retaining ring, residual stresses having undesirably high values are expected to remain within the polymeric material of end member EMB in one or more of the aforementioned areas. For example, the stresses in areas PSA, PSB and PSC are shown in FIG. 18 as being predicted to potentially exceed about 150 MPa in area PSA, 60 MPa in area PSB and 40 MPa in area PSC, as estimated using finite element modeling and analysis.

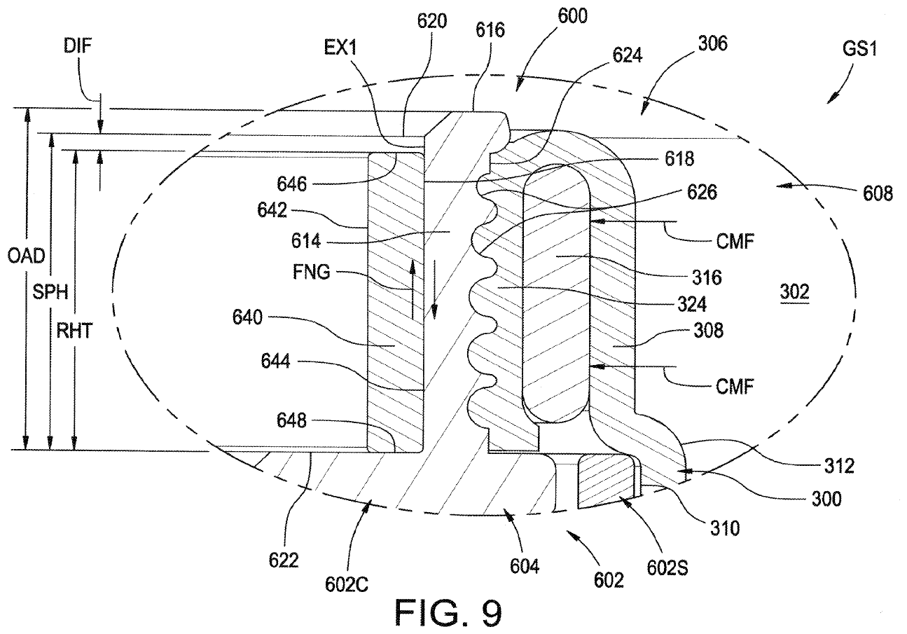

With further reference, now, to the subject matter of the present disclosure, FIGS. 6, 7 and 9 illustrate one non-limiting example of end member assembly 600 including an endless annular ring 640 that is disposed along crimp wall portion 614. Endless annular ring 640, which may also be referred to in the art as a backing ring, is operative to buttress the crimp wall portion 614 against radially-inward forces associated with crimping or other radially-inward deformation of retaining ring 316 to compressively engage an end wall portion 324 of flexible wall 308 between the retaining ring and the crimp wall portion. Such radially-inward forces are represented in FIGS. 9-11 by arrows CMF, such as have been described above in connection with conventional constructions. Endless annular ring 640 includes an inner side surface portion 642 facing radially inward and an outer side surface portion 644 facing radially outward. Endless annular ring 640 extends axially from an end surface portion 646 toward an end surface portion 648 that is offset from end surface portion 646 such that the endless annular ring has a ring height defined therebetween, such as is represented in FIGS. 9-11 by reference dimension RHT. In a preferred arrangement, endless annular ring 640 is formed from a metal material or a polymeric material that has substantially increased rigidity relative to the polymeric material of end member body 602 and, particularly, crimp wall portion 614 thereof.

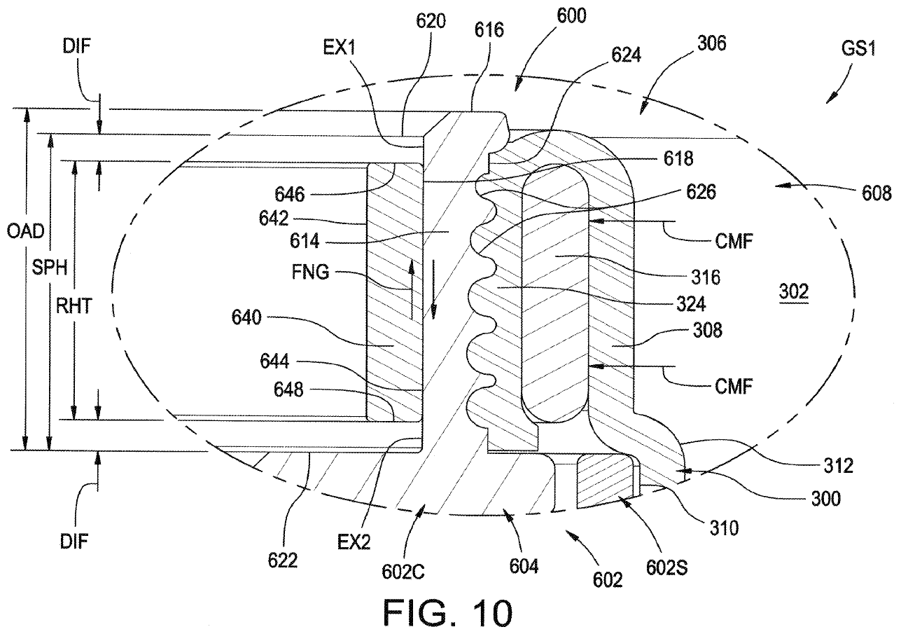

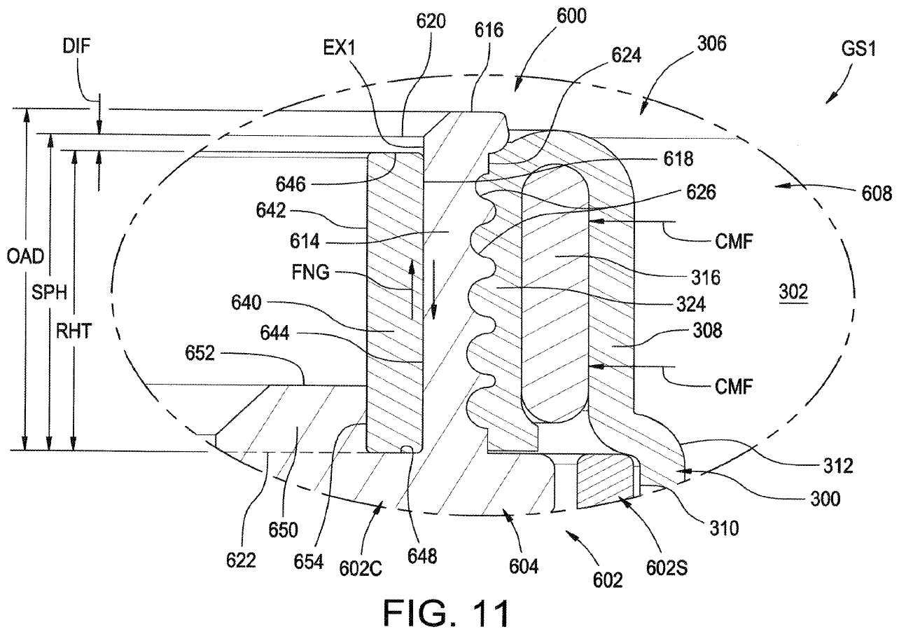

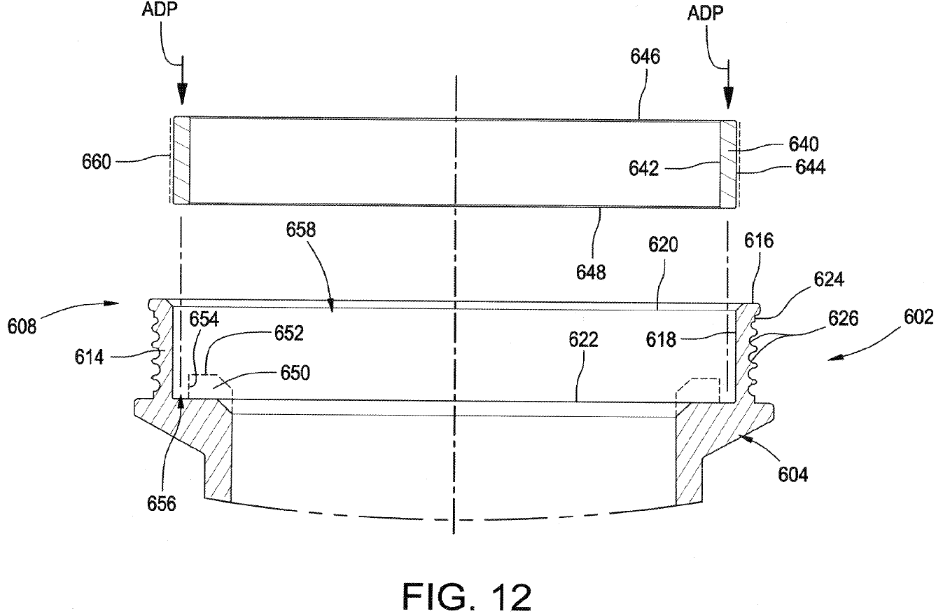

In a preferred arrangement, axial extent 622 of inner side surface portion 618 of crimp wall portion 614 is axially offset from axial extent 620 such that inner side surface portion 618 has an inner side surface portion height, such as is represented in FIGS. 9-11 by reference dimension SPH. Additionally, or in the alternative, axial extent 622 is axially offset from end surface portion 616 such that inner side surface portion 618 has an overall axial extent or depth, such as is represented in FIG. 9 by reference dimension OAD. In a preferred arrangement, inner side surface portion height SPH (and overall axial depth OAD) can be greater than ring height RHT, such as is represented in at least FIG. 9 by reference dimension DIF. In such an arrangement, endless annular ring 640 can be positioned along inner side surface portion 618 such that at least one annular section of inner side surface portion 618 of crimp wall portion 614 is exposed axially outwardly of endless annular ring 640. In the arrangement shown in FIGS. 6, 7 and 9, an exposed annular section EX1 extends between end surface portion 646 and axial extent 620 of the inner side surface portion. In such an arrangement, endless annular ring 640 can, optionally, be positioned relative to end member wall 604 such that end surface portion 648 of endless annular ring 640 is at least approximately coplanar with axial extent 622 of inner side surface portion 618 of crimp wall portion 614. An alternate arrangement is shown in FIG. 10 in which endless annular ring 640 is positioned along inner side surface portion 618 such that an exposed annular section EX1 extends between end surface portion 646 and axial extent 620 with another exposed annular section EX2 extending between end surface portion 648 and axial extent 622. Another alternate arrangement is shown in FIG. 11 in which endless annular ring 640 is positioned along inner side surface portion 618 such that an exposed annular section EX1 extends between end surface portion 646 and axial extent 620. Additionally, end member wall 604 includes an inner wall portion 650 that extends axially from along axial extent 622 in a direction toward axial extent 620. Inner wall portion 650 includes an end surface portion 652 that is axially offset from axial extent 622 of inner side surface portion 618. Inner wall portion 650 also includes an outer side surface portion 654 that extends peripherally about axis AX and axially between axial extent 622 and end surface portion 652 such that an annular channel or groove 656 (FIG. 12) is disposed radially between inner side surface portion 618 and outer side surface portion 654. In such an arrangement, endless annular ring 640 can, optionally, be positioned relative to end member wall 604 such that end surface portion 648 of endless annular ring 640 is at least approximately coplanar with axial extent 622 of inner side surface portion 618 of crimp wall portion 614.

It will be appreciated that inner side surface portion 618 of crimp wall portion 614 is configured without an end member wall portion (e.g., end member wall portion WP1 in FIG. 15) that extends radially inward of any substantial portion of endless annular ring 640. In a preferred arrangement, inner side surface portion 618 can be configured without such an end member wall portion that extends radially inward beyond any substantial portion of endless annular ring 640 from axially along axial extent 622 to at least axial extent 620 and, preferably, to end surface portion 616. As such, inner side wall portion 618 forms an open end 658 with an unobstructed side surface portion that is dimensioned to receive endless annular ring 640. In some cases, inner side surface portion 618 can have an approximately linear cross-sectional profile. In some cases, the approximately linear cross-sectional profile can be disposed in approximate alignment with longitudinal axis AX. In such cases, the cross-sectional profile can be swept around axis AX to generate inner side surface portion 618 with an approximately cylindrical shape or configuration. In a preferred arrangement, all or substantially all of crimp wall portion 614 is disposed radially outward of endless annular ring 640 in an assembled condition. In such a construction, endless annular ring 640 can be provided separately from end member body 602. Endless annular ring 640 can be axially displaced (e.g., pressed or otherwise axially forced) into axially coextensive engagement with at least some of crimp wall portion 614, such as is represented in FIG. 12 by arrows ADP representing axial displacement of endless annular ring relative to end member body 602.

Preferably, inner side surface portion 618 of crimp wall portion 614 and outer side surface portion 644 of endless annular ring 640 will be dimensioned to form either a press or transition fit with one another. As such, endless annular ring 640 can be displaced into axially coextensive engagement with crimp wall portion 614 and retained in position through frictional engagement between surface portions 618 and 644, such as is represented in FIGS. 9-11 by frictional engagement arrows FNG. It will be appreciated, however, that an adhesive or tack agent could be included on or along either of both of such surface portions to aid in retaining endless annular ring 640 in a desired position along crimp wall portion 614, as described above. Such an adhesive or tack agent is represented in FIG. 12 by dashed lines 660. In any case, endless annular ring 640 is positioned and retained on or along crimp wall portion 614 to increase radial rigidity without axially capturing the endless annular ring between polymeric wall portions of the end member body, which can generate undesirable stresses within the polymeric material, as described in detail above in connection with conventional constructions.

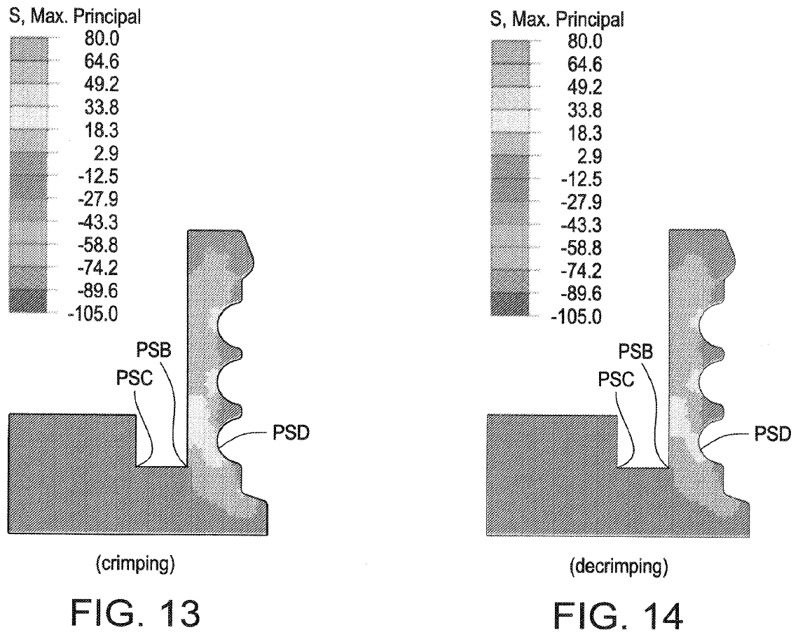

As non-limiting examples, FIGS. 13 and 14 illustrate graphical representations of stresses within the polymeric material of end member body 602 under various conditions of use. As discussed above, endless annular ring 640 is provided separately from end member body 602, which is manufactured from polymeric material separately from endless annular ring 640, such as by way of an injection molding process, for example. Because the endless annular ring is not insert molded into the end member body, those residual stresses illustrated in FIG. 16 that are generally associated with the cooling of components having differing coefficients of thermal expansion are substantially-entirely eliminated from end member assemblies in accordance with the subject matter of the present disclosure. As such, a graphical representation for the constructions shown in FIGS. 6, 7 and 9-12 for end member body 602 with residual stresses from cooling of a multi-material construction is not included herein. Additionally, it will be recognized from FIGS. 13 and 14 that area PSA from FIGS. 16-18 is simply absent from FIGS. 13 and 14 due to the absence of the corresponding geometric features of end member body 602 (i.e., the absences of an equivalent of end member wall portion WP1 in FIG. 15).

The elimination of residual stresses associated with cooling of components having differing coefficients of thermal expansion from end member body 602 also results in a substantial reduction (or near elimination) of stresses within the end member body during and after undergoing a crimping process, such as has been described above in detail in connection with FIGS. 17 and 18 in relation to known constructions. With regard to the subject matter of the present disclosure, residual stresses having a lower, more-desirable value within the remaining areas of end member body 602 are illustrated in FIGS. 13 and 14 as identified by areas PSB and PSC. More specifically, FIG. 13 illustrates stresses associated with actions of crimping or otherwise generating radially-inward forces, as represented by arrows CMF, to deform retaining ring 316 radially inward and thereby compressively engage end wall portion 324 of flexible wall 308 along crimp wall portion 614 as radially buttressed by endless annular ring 640. As examples, stresses in areas PSB and PSC are shown in FIG. 13 as being predicted to be less than about 3 MPa in area PSB and less than 3 MPa in area PSC, as estimated using finite element modeling and analysis.

FIG. 14 illustrates stresses remaining within end member body 602 upon abatement of crimping forces CMF associated with deforming retaining ring 316. That is, once retaining ring 316 has been deformed into a final crimped condition and end wall portion 324 is compressively disposed between crimp wall portion 614 and retaining ring 316, residual stresses having a lower, more-desirable value remain within the polymeric material of end member body 602 in one or more of the aforementioned areas. Again, as examples, stresses in areas PSB and PSC are shown in FIG. 14 as being predicted to be less than about 3 MPa in area PSB and less than 3 MPa in area PSC, as estimated using finite element modeling and analysis. It will be recognized an appreciated from the foregoing, that the subject matter of the present disclosure is expected to result in elimination of excessively high stresses in area PSA in FIGS. 16-18 as well as a substantial reduction in stresses in areas PSB and PSC as illustrated by the comparative differences between FIGS. 13 and 17 as well as illustrated by the comparative differences between FIGS. 14 and 18.

Additionally, for reference purposes, an area is identified by the reference characters PSD as having stresses on or along crimp wall portion 614. More specifically, area PSD represents stresses associated with a crimped connection of end wall portion 324 on or along outer side surface portion 624 of crimp wall portion 614 as generated or otherwise developed by retaining ring 316 compressively engaging the crimp wall portion while buttressed by endless annular ring 640. It will be appreciated that crimp wall portion 614 may be designed or otherwise constructed to accommodate stresses of a greater value than in other areas of end member body 602. For example, stresses in area PSD are shown in FIG. 13 as being predicted to be less than about 50 MPa and are shown in FIG. 14 as being predicted to be less than about 40 MPa, as estimated using finite element modeling and analysis.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure. To aid the Patent Office and any readers of this application and any resulting patent in interpreting the claims appended hereto, Applicant does not intend any of the appended claims or any claim elements to invoke 35 U.S.C. 112(f) unless the words “means for” or “step for” are explicitly used in the particular claim.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A method of manufacturing a gas spring assembly that includes a longitudinal axis, said method comprising:
forming an end member body that extends axially between a first body end and a second body end, said end member body including a body wall formed from a polymeric material, said body wall extending peripherally around said longitudinal axis and axially between said first and second body ends, said body wall including a crimp wall portion extending axially and including an inner side surface portion facing radially inward and an outer side surface portion facing radially outward;
positioning a first endless annular ring formed separately from said end member body in abutting engagement with inner side surface portion of said crimp wall portion of said end member body thereby at least partially forming an end member assembly, said first endless annular ring disposed axially coextensive with at least some of said outer side surface portion of said crimp wall portion with said first endless annular ring frictionally engaging said inner side surface portion of said crimp wall portion with said first endless annular ring physically unobstructed and otherwise unconstrained by said body wall in at least one axial direction;
positioning an end of a flexible wall of a gas spring flexible member that at least partially defines a spring chamber along said end member assembly such that said end of said flexible wall is disposed along said outer side surface of said crimp wall portion of said end member body;
positioning a second endless annular ring along said end of said flexible wall such that said second endless annular ring is axially coextensive with said crimp wall portion and said first endless annular ring; and,
displacing said second endless annular ring radially inward such that said second endless annular ring generates radially-inward forces compressively engaging said flexible wall along said outer side surface portion of said crimp wall portion of said end member assembly such that a fluid-tight seal is formed therebetween with said first endless annular ring providing increased radial rigidity to said crimp wall portion under said radially-inward forces.

2.-4. (canceled)

5. A method according to claim 1, wherein said inner side surface portion of said crimp wall portion extends axially between a first inner edge disposed toward said first body end and a second inner edge disposed toward said second body end relative to said first inner edge, said first endless annular ring includes an outer peripheral side surface portion facing radially outward, an inner peripheral side surface portion facing radially inward and a first end surface portion oriented transverse to said longitudinal axis, and positioning said first endless annular ring includes axially displacing said first endless annular ring relative to said end member body such that said outer peripheral side surface portion is disposed in abutting engagement with said inner side surface portion of said crimp wall portion.

6. A method according to claim 5, wherein axially displacing said first endless annular ring relative to said end member body includes axially displacing said first endless annular ring until said first end surface portion is offset from said first inner edge by a first offset distance such that an exposed annular section of said inner side surface portion of said crimp wall portion extends from along said first end surface portion of said first endless annular ring to said first inner edge.

7. A method according to claim 5, wherein said first endless annular ring includes a second end surface portion offset from said first end surface portion such that a ring height is defined therebetween, and axially displacing said first endless annular ring relative to said end member body includes axially displacing said first endless annular ring until said second end surface portion is offset from said second inner edge by a second offset distance such that an exposed annular section of said inner side surface portion of said crimp wall portion extends from along said second end surface portion of said first endless annular ring to said second inner edge.

8. A method according to claim 5, wherein said first endless annular ring includes a second end surface portion offset from said first end surface portion such that a ring height is defined therebetween, and axially displacing said first endless annular ring relative to said end member body includes axially displacing said first endless annular ring until said second end surface portion is approximately coplanar with said second inner edge.

9. A method according to claim 1, wherein said end member body includes a distal end surface portion disposed along said first body end, said inner side surface portion of said crimp wall portion extends axially inward from along said first body end between a first inner edge disposed toward said first body end and a second inner edge disposed toward said second body end relative to said first inner edge, and forming said end member body includes forming said end member body such that substantially-all of said end member body extending from along said second inner edge of said inner side surface portion axially outward to said distal end surface portion of said end member body is disposed radially outward of said crimp wall portion such that said first endless annular ring is unobstructed by said crimp wall portion from said second inner edge of said inner side surface portion to said distal end surface portion of said end member body.

10. A method according claim 1, wherein forming said end member body includes forming said body wall with an inner wall portion disposed radially inward of said crimp wall portion and axially coextensively therewith such that an annular channel is disposed between said inner side surface portion of said crimp wall portion and an outer side wall portion of said inner wall portion, and positioning said first endless annular ring in abutting engagement along said inner side surface portion of said crimp wall portion includes positioning at least some of said first endless annular ring within said annular channel.

11. An end member assembly dimensioned to receive an associated open end of an associated gas spring flexible member, said end member assembly comprising:
an end member body having a longitudinal axis and extending axially between a first body end and a second body end, said end member body including a body wall formed from a polymeric material, said body wall extending peripherally around said longitudinal axis and axially between said first and second body ends, said body wall including a crimp wall portion extending axially and including an inner side surface portion facing radially inward, and said crimp wall portion including an outer side surface portion facing radially outward and dimensioned to receive therealong the associated open end of the associated gas spring flexible member; and,
an endless annular ring formed separately from said end member body, said endless annular ring positioned in abutting engagement with said crimp wall portion along said inner side surface portion thereof and disposed axially coextensive with at least some of said outer side surface portion such that said endless annular ring provides increased radial rigidity to said crimp wall portion under radially-inward forces associated with securing the associated open end of the associated gas spring flexible member along said crimp wall portion;
said crimp wall portion disposed radially outward of said endless annular ring with said endless annular ring frictionally engaging said inner side surface portion of said crimp wall portion but otherwise unconstrained in at least one axial direction by said body wall.

12.-16. (canceled)

17. An end member assembly according to claim 11, wherein said endless annular ring includes a first end surface portion oriented transverse to said longitudinal axis and a second end surface portion axially offset from said first end surface portion, an outer peripheral side surface portion facing radially outward and an inner peripheral side surface portion facing radially inward, said outer peripheral side surface portion and said inner peripheral side surface portion extending around said longitudinal axis between said first and second end surface portions, and with said outer peripheral side surface portion disposed in abutting engagement with said inner side surface portion of said crimp wall portion.

18. (canceled)

19. An end member assembly according to claim 17, wherein substantially-all of said crimp wall portion extending from along said first end surface portion of said endless annular ring in a direction opposite said second end surface portion is disposed radially outward of said-crimp endless annular ring.

20. An end member assembly according to claim 11, wherein said inner side surface portion extends axially between a first inner edge disposed toward said first body end and a second inner edge disposed toward said second-inner body end relative to said first inner edge.

21. An end member assembly according to claim 11, wherein said endless annular ring includes an outer peripheral side surface portion facing radially outward, an inner peripheral side surface portion facing radially inward and a first end surface portion oriented transverse to said longitudinal axis, said outer peripheral side surface portion disposed in abutting engagement with said inner side surface portion of said crimp wall portion, and said first end surface portion axially offset from said first inner edge by a first offset distance.

22. An end member assembly according to claim 21, wherein an exposed annular section of said inner side surface portion of said crimp wall portion extends from along said first end surface portion of said endless annular ring to said first inner edge.

23. An end member assembly according to claim 21, wherein said endless annular ring includes a second end surface portion offset from said first end surface portion such that a ring height is defined therebetween.

24. An end member assembly according to claim 23, wherein said exposed annular section is a first exposed annular section, and a second exposed annular section of said inner side surface portion of said crimp wall portion extends from along said second end surface portion of said endless annular ring to said second inner edge.

25. An end member assembly according to claim 20, wherein substantially-all of said crimp wall portion from said second inner edge to said first inner edge is disposed radially outward of said endless annular ring.

26. (canceled)

27. A gas spring assembly comprising:
a gas spring flexible member having a longitudinal axis, said gas spring flexible member including a flexible wall extending peripherally about said longitudinal axis and axially between a first end and a second end to at least partially define a spring chamber therebetween; and,
an end member assembly according to claim 11 at least partially received within said first end of said gas spring flexible member such that a portion of said flexible wall is disposed along said outer side surface portion of said crimp wall portion; and,
an annular retaining ring extending peripherally around said longitudinal axis, said annular retaining ring positioned coextensive with said crimp wall portion and said endless annular ring, said retaining ring disposed radially outward of said flexible spring member and generating radially-inward forces to compressively engage said flexible wall along said outer side surface portion of said crimp wall portion of said end member assembly such that a fluid-tight seal is formed therebetween.

28. A gas spring assembly comprising:
a flexible spring member having a longitudinal axis and including a flexible wall extending peripherally about said longitudinal axis between first and second ends of said flexible spring member such that a spring chamber is at least partially defined therebetween;
an end member secured across said first end of said flexible wall such that a fluid-tight connection is formed therebetween;
an end member assembly extending across said second end of said flexible wall, said end member assembly including:
an end member body extending peripherally about said longitudinal axis, said end member body including a body wall formed from a polymeric material, said body wall including a crimp wall portion that includes an inner side surface portion facing radially inward and an outer side surface portion facing radially outward, said inner side surface portion extending axially between a first inner edge and a second inner edge axially offset from said first inner edge, said crimp wall portion received within said second end of said flexible spring member such that said flexible wall is disposed along said outer side surface portion; and,
a first endless annular ring formed separately from said end member body, said first endless annular ring including an outer peripheral side surface portion, an inner peripheral side surface portion and a first end surface portion oriented transverse to said longitudinal axis;
said first endless annular ring positioned along said crimp wall portion such that said outer peripheral side surface portion is disposed in abutting engagement with said inner side surface portion of said crimp wall portion, said first endless annular ring frictionally engaging said inner side surface portion of said crimp wall portion with substantially-all of said crimp wall portion from said second inner edge to said first inner edge is disposed radially outward of said first endless annular ring such that said first endless annular ring is unobstructed by said crimp wall portion in at least one axial direction; and,
a second endless annular ring extending peripherally around said longitudinal axis, said second endless annular ring positioned coextensive with said crimp wall portion of said end member body and coextensive with said first endless annular ring, said second endless annular ring disposed radially outward of said flexible spring member such that a portion of said flexible wall is disposed between said second endless annular ring and said crimp wall portion, said second endless annular ring generating radially-inward forces compressively engaging said flexible wall along said outer side surface portion of said crimp wall portion such that a fluid-tight seal is formed therebetween.

29. A gas spring assembly according to claim 28, wherein an exposed annular section of said inner side surface portion of said crimp wall portion extends from along said first end surface portion of said first endless annular ring to said first inner edge with said exposed annular section extending in substantial alignment with said outer peripheral side surface portion of said first endless annular ring.

30. A gas spring assembly according to claim 29, wherein said exposed annular section is a first exposed annular section, and a second exposed annular section of said inner side surface portion of said crimp wall portion extends from along said second end surface portion of said first endless annular ring to said second inner edge.
